(19) United States
(12) Patent Application Publication
(10) Pub. No.: US 2008/0189090 A1
(43) Pub. Date: Aug. 7, 2008

(54) System and Method for Determining a Guard Band for an Operating Voltage of an Integrated Circuit Device

(76) Inventors: Makoto Aikawa, Tokyo (JP); Sang H. Dhong, Austin, TX (US); Brian Flachs, Georgetown, TX (US); Gilles Gervais, Austin, TX (US); Yoichi Nishino, Tokyo (JP); Iwao Takiguchi, Tokyo (JP); Tetsuji Tamura, Tokyo (JP); Yaping Zhou, Austin, TX (US)

Correspondence Address: IBM CORP. (WIP);c/o WALDER INTELLECTUAL PROPERTY LAW, P.C., P.O. BOX 832745, RICHARDSON, TX, 75083, US

(21) Appl. No.: 11/671,852

(22) Filed: Feb. 6, 2007

(51) Int. Cl. G06G 7/62; G06F 17/50

(52) U.S. Cl. 703/4; 703/14

(57) ABSTRACT

A system and method for determining a guard band for an operating voltage of an integrated circuit device are provided. The system and method provide a mechanism for calculating the guard band based on a comparison of simulated noise obtained from a simulation of the integrated circuit device using a worst case waveform stimuli with simulated or measured power supply noise of a workload/test pattern that may be achieved using testing equipment. A scaling factor for the guard band is determined by comparing results of a simulation of a workload/test pattern with measured results of the workload/test pattern as applied to a hardware implementation of the integrated circuit device. This scaling factor is applied to a difference between the noise generated through simulation of the workload/test pattern and the noise generated through simulation of the worst case current waveform to generate a guard band value.

### BACKGROUND

1. Technical Field

The present application relates generally to an improved data processing system and method. More specifically, the present application is directed to a system and method for determining a guard band for an operating voltage of an integrated circuit device.

2. Description of Related Art

The performance and power dissipation of an integrated circuit device depends on multiple factors. For example, operating temperature, the process used to fabricate the integrated circuit device, and operating voltage all affect how the integrated circuit device will perform and the power that the integrated circuit device dissipates. Performance tends to vary with process linearly, varies with operating temperature in an inverse logarithmic relationship, and varies with operating voltage exponentially. Power dissipation tends to vary with process somewhat linearly, with operating temperature exponentially, and with operating voltage exponentially. With these relationships, it can be seen that it is important in the design of modern integrated circuit devices to determine the lowest supply voltage, i.e. VminF, in order to guarantee that the integrated circuit device will function with the least power dissipation.

Typically, in order to determine the lowest supply voltage, worst case current waveforms (di/dt) are usually used to test an integrated circuit device. In order to determine the worst case current waveform, the integrated circuit device is subjected to testing based on various current waveforms as stimuli. The resulting noise of the supply voltage applied to the integrated circuit device is measured. The testing of the integrated circuit device is performed iteratively with each iteration using a different current waveform that progressively generates a greater noise in the supply voltage of the integrated circuit device.

While various current waveforms may be generated for testing the integrated circuit device, typically the workloads/tests that may be generated by testing equipment cannot generate the worst case current waveforms di/dt due to limitations of the testing equipment, difficulty in generating worst case workload, and difficulty in obtaining hardware representative of extreme ends of the process distribution. To the contrary, the testing only provides an empirically determined minimum supply voltage VminF for the integrated circuit device.

In order to ensure that the integrated circuit device will support the worst case operating scenario, i.e. the worst case current waveform, a guard band is typically added to the empirically determined minimum supply voltage VminF. The guard band is typically estimated based on the human designer's educated extrapolation of the results obtained during testing of the integrated circuit device. Thus, there may be considerable uncertainty in the estimation of the guard band to apply to the empirically determined minimum supply voltage VminF.

### SUMMARY

In view of the above, it would be beneficial to have a system and method for determining a guard band for the minimum supply voltage of an integrated circuit device that significantly reduces the uncertainty in the determination of the guard band. The illustrative embodiments provide such a system and method.

The illustrative embodiments provide a mechanism for calculating the guard band based on a comparison of simulated noise obtained from a simulation of the integrated circuit device using a worst case waveform stimuli with simulated or measured power supply noise of a workload/test pattern that may be achieved using testing equipment. A scaling factor k for the guard band is determined by comparing results of a simulation of a workload/test pattern with measured results of the workload/test pattern as applied to a hardware implementation of the integrated circuit device, i.e. k=measured_noise/simulated_noise.

In one illustrative embodiment, this scaling factor k is applied to a difference between the noise generated through simulation of the workload/test pattern and the noise generated through simulation of the worst case current waveform to generate a guard band value, i.e. a VminF voltage offset (VVO). In other words, the VVO is defined using the following equation: VVO=k*(Noiseᵥₛᵢₘ_{_{—}}ₜₑₛₜₚₐₜₜₑᵣₙ−Noiseᵥₛᵢₘ_{_{—}}_{worstcase}). The resulting guard band defined by VVO is applied to the minimum supply voltage VminF determined from application of the specific workload/test pattern to the integrated circuit device, in order to obtain the real minimum supply voltage condition. Thereby, the minimum operating voltage for the integrated circuit device that achieves the least power dissipation may be determined and used with the integrated circuit device.

In one illustrative embodiment, a method for determining a guard band for an operating voltage of an integrated circuit device is provided. The method may comprise simulating the integrated circuit device under a selected workload to thereby generate first simulated results and simulating the integrated circuit device using a worst case current waveform to thereby generate second simulated results. The method may further comprise calculating a guard band based on the first simulated results and second simulated results and applying the guard band to an operating voltage of the integrated circuit device to obtain a minimum operating voltage for the integrated circuit device. Simulating the integrated circuit device may comprise performing power dissipation simulations.

The method may further comprise measuring a hardware implementation of the integrated circuit device under the selected workload to thereby generate measured results. Calculating the guard band may further be based on the measured results. Moreover, calculating the guard band may comprise calculating a scaling factor based on a relationship between the measured results and the first simulated results. Calculating the guard band may further comprise calculating a difference between the first simulated results and the second simulated results and multiplying the difference by the scaling factor to obtain the guard band. The relationship may be a ratio of the measured results to the first simulated results.

The first simulated results may be an estimate of noise of a supply voltage applied to the integrated circuit device based on the selected workload. The second simulated results may be an estimate of noise of the supply voltage applied to the integrated circuit device based on the worst case current waveform.

The selected workload may be a workload that may be generated by testing equipment to verify an operation of a hardware implementation of the integrated circuit device. The selected workload may be one of a logical built-in self test (LBIST) test pattern or an array built-in self test (ABIST) test pattern. The selected workload may be an impulse response workload of a logical built-in self test.

In other illustrative embodiments, a computer program product comprising a computer useable medium having a computer readable program is provided. The computer readable program, when executed on a computing device, causes the computing device to perform various ones, and combinations of, the operations outlined above with regard to the method illustrative embodiment.

In yet another illustrative embodiment, an apparatus is provided. The apparatus may comprise a processor and a memory coupled to the processor. The memory may comprise instructions which, when executed by the processor, cause the processor to perform various ones, and combinations of, the operations outlined above with regard to the method illustrative embodiment.

These and other features and advantages of the present invention will be described in, or will become apparent to those of ordinary skill in the art in view of, the following detailed description of the exemplary embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an exemplary block diagram of a distributed data processing system in which aspects of the illustrative embodiments may be implemented;

FIG. 2 is a block diagram of an exemplary data processing device in which exemplary aspects of the illustrative embodiments may be implemented;

FIG. 3 is an exemplary block diagram of a circuit simulation engine in accordance with one illustrative embodiment;

FIG. 4A is an exemplary worst case current waveform in accordance with one exemplary embodiment;

FIG. 4B is an exemplary impulse current waveform in accordance with one exemplary embodiment;

FIG. 4C is an exemplary measured impulse response waveform in accordance with one exemplary embodiment;

FIG. 4D is an exemplary simulated impulse response waveform in accordance with one exemplary embodiment;

FIG. 4E is an exemplary simulated noise waveform for a simulation in which the worst case current waveform of FIG. 4A is applied in accordance with one illustrative embodiment;

FIG. 4F illustrates a voltage waveform obtained from simulation of a LBIST pattern to the integrated circuit model in order to obtain a VminF value; and

FIG. 5 is a flowchart outlining an exemplary operation of an illustrative embodiment for calculating and applying a guard band to a minimum operational voltage determined through simulation of an integrated circuit device.

### DETAILED DESCRIPTION OF THE ILLUSTRATIVE EMBODIMENTS

The illustrative embodiments provide a mechanism for determining a guard band for an operating voltage of an integrated circuit device, such as an integrated circuit chip. The guard band may be added to a minimum operating voltage determined through simulation and/or testing of the integrated circuit device in order to identify a worst case supply voltage for the integrated circuit device. In this way, the lowest supply voltage VminF of the integrated circuit device that provides the least power dissipation may be identified. The integrated circuit device may then be operated using a supply voltage determined based on this lowest supply voltage VminF identified using the mechanisms of the illustrative embodiments.

The illustrative embodiments may be implemented in a single data processing system or may be distributed across a plurality of data processing systems that are coupled to one another via one or more communications networks. For example, a server computing device may provide circuit model simulation and analysis engines that may be applied to integrated circuit designs or models provided by other computing devices, such as client computing devices. A client computing device may communicate with the server computing device via the one or more communications networks so as to control the application of simulation and analysis engines of the illustrative embodiments to the integrated circuit models, which may be provided, for example, as netlist data structures, hardware description language files, or the like. Alternatively, the integrated circuit models and analysis engines may be provided entirely on the same computing device such that multiple computing devices and communication networks are not necessary. For purposes of the present description, however, it will be assumed that the illustrative embodiments are implemented in a distributed data processing system.

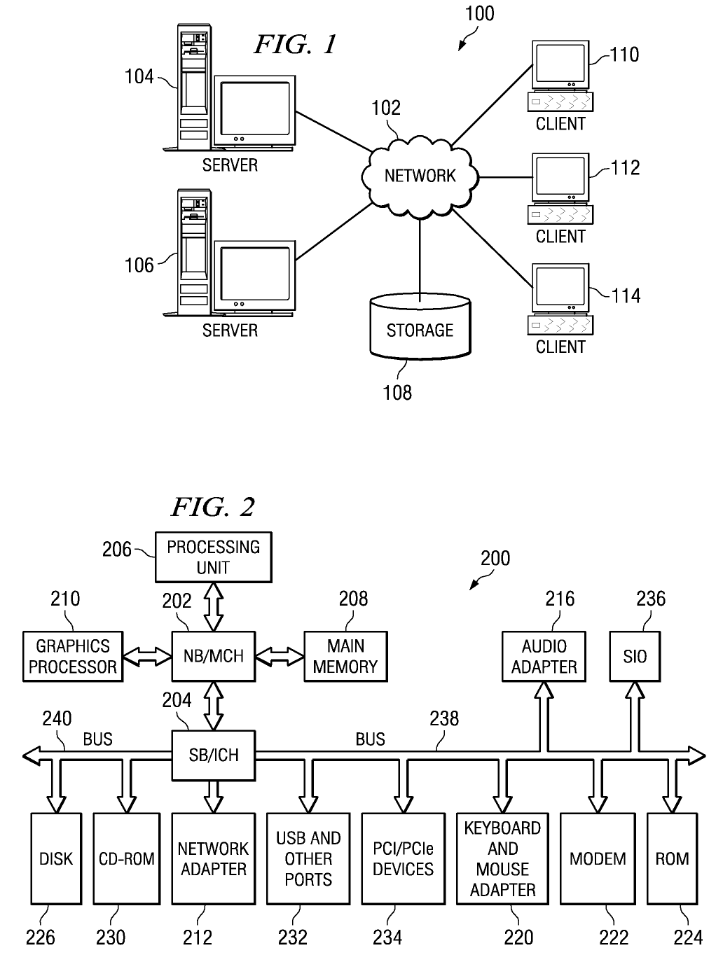

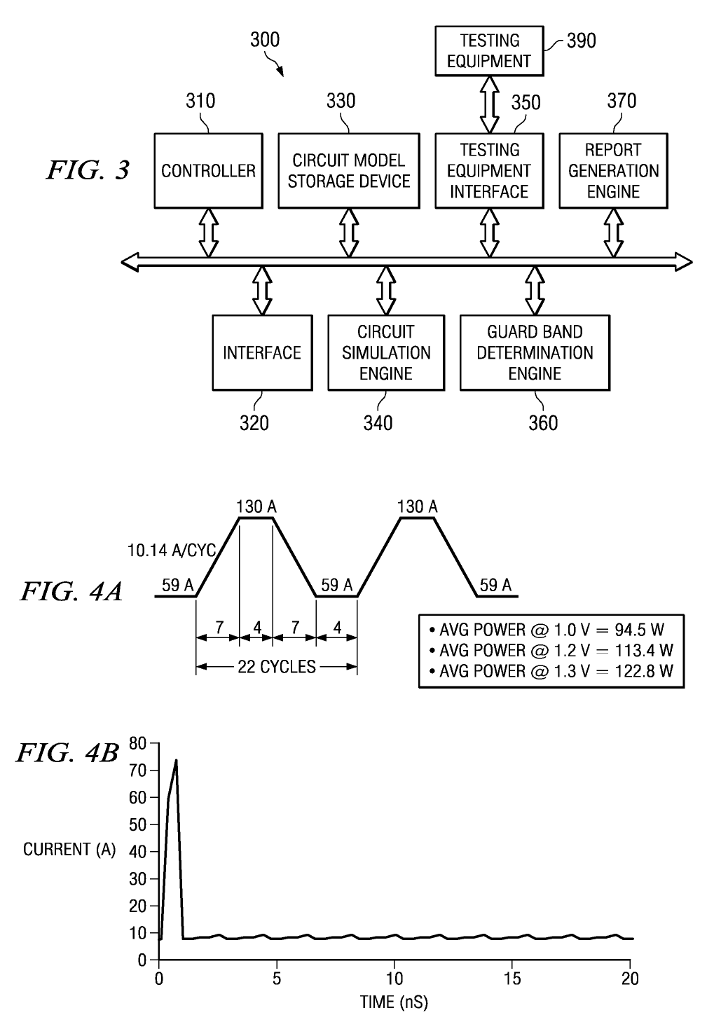

With reference now to the figures and in particular with reference to FIGS. 1-2, exemplary diagrams of data processing environments are provided in which exemplary embodiments of the present invention may be implemented. It should be appreciated that FIGS. 1-2 are only exemplary and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 1 depicts a pictorial representation of an exemplary distributed data processing system in which aspects of the illustrative embodiments may be implemented. Distributed data processing system 100 may include a network of computers in which embodiments of the illustrative embodiments may be implemented. The distributed data processing system 100 contains at least one network 102, which is the medium used to provide communication links between various devices and computers connected together within distributed data processing system 100. The network 102 may include connections, such as wire, wireless communication links, or fiber optic cables.

In the depicted example, server 104 and server 106 are connected to network 102 along with storage unit 108. In addition, clients 110, 112, and 114 are also connected to network 102. These clients 110, 112, and 114 may be, for example, personal computers, network computers, or the like. In the depicted example, server 104 provides data, such as boot files, operating system images, and applications to the clients 110, 112, and 114. Clients 110, 112, and 114 are clients to server 104 in the depicted example. Distributed data processing system 100 may include additional servers, clients, and other devices not shown.

In the depicted example, distributed data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed data processing system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the present invention, and therefore, the particular elements shown in FIG. 1 should not be considered limiting with regard to the environments in which the illustrative embodiments of the present invention may be implemented.

With reference now to FIG. 2, a block diagram of an exemplary data processing system is shown in which aspects of the illustrative embodiments may be implemented. Data processing system 200 is an example of a computer, such as server 104 or client 110 in FIG. 1, in which computer usable code or instructions implementing the processes for illustrative embodiments of the present invention may be located.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206. The operating system coordinates and provides control of various components within the data processing system 200 in FIG. 2. As a client, the operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java™ programs or applications executing on data processing system 200 (Java is a trademark of Sun Microsystems, Inc. in the United States, other countries, or both).

As a server, data processing system 200 may be, for example, an IBM® eServer™ pSeries® computer system, running the Advanced Interactive Executive (AIX®) operating system or the LINUX® operating system (eServer, pSeries and AIX are trademarks of International Business Machines Corporation in the United States, other countries, or both while LINUX is a trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for illustrative embodiments of the present invention may be performed by processing unit 206 using computer usable program code, which may be located in a memory such as, for example, main memory 208, ROM 224, or in one or more peripheral devices 226 and 230, for example.

A bus system, such as bus 238 or bus 240 as shown in FIG. 2, may be comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, may include one or more devices used to transmit and receive data. A memory may be, for example, main memory 208, ROM 224, or a cache such as found in NB/MCH 202 in FIG. 2.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device which is configured with flash memory to provide non-volatile memory for storing operating system files and/or user-generated data, for example. Essentially, data processing system 200 may be any known or later developed data processing system without architectural limitation.

With one illustrative embodiment, a client computing device may provide an integrated circuit model to a server computing device in which simulation and analysis engines are provided. As part of the simulation of the integrated circuit model, the mechanisms of the illustrative embodiments may simulate the integrated circuit model using a worst case current waveform to thereby generate a worst case noise estimate. In addition, the simulation engine may further simulate the operation of the integrated circuit model using a workload/test pattern that is achievable by testing equipment that may be used to verify the operation of a hardware implementation of the integrated circuit model. For example, this workload/test pattern may be a logical built-in self test (LBIST) test pattern, array built-in self test (ABIST), or any other test pattern that is of a critical nature for testing the operation of the integrated circuit device. In one illustrative embodiment, the workload/test pattern that is applied as part of the simulation is an impulse response workload using a LBIST test pattern.

The noise results of the simulations performed by the application of the worst case current waveform and the achievable workload/test pattern are measured as part of the simulation. These noise results are then used by the simulation engine to calculate a guard band for the minimum operating voltage obtained from simulation of the integrated circuit model using the achievable workload/test pattern. The calculation of the guard band further comprises the calculation of a scaling factor based on a comparison of measured noise for an achievable workload/test pattern and simulated noised for the same achievable workload/test pattern. From this, the actual minimum supply voltage in which the least power dissipation may be identified as the minimum operating voltage plus the guard band.

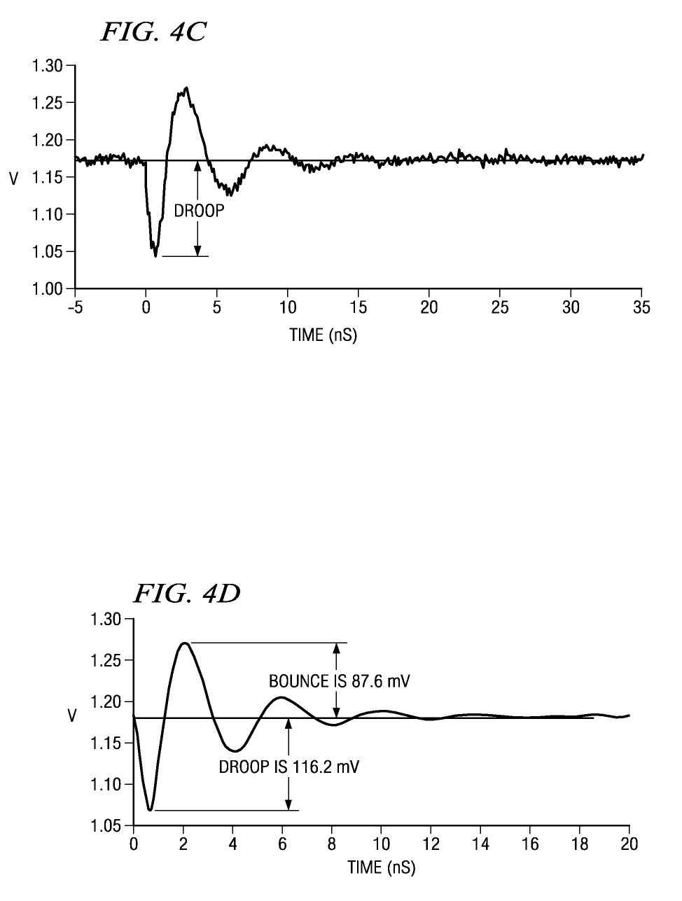

FIG. 3 is an exemplary block diagram of a simulation engine in accordance with one illustrative embodiment. The elements shown in FIG. 3 may be implemented in hardware, software, or any combination of hardware and software. In one illustrative embodiment, the elements in FIG. 3 are implemented as software instructions executed by one or more data processing devices. The elements of FIG. 3 may be implemented entirely within one computing device or may be distributed across a plurality of computing devices.

As shown in FIG. 3, the circuit simulation system 300 includes a controller 310, an interface 320, a circuit model storage device 330, a circuit simulation engine 340, a testing equipment interface 350, a guard band determination engine 360, and a report generation engine 370. The controller 310 controls the overall operation of the circuit simulation system 300 and orchestrates the operation of the other elements 320-370. The interface 320 provides a communication interface through which integrated circuit model information may be received from other applications and/or other computing devices. The interface 320 may be a network interface through which integrated circuit model information may be received from one or more client devices and results of simulation may be provided to the one or more client devices. The interface 320 may also be an interface through which user input is received to configure simulations performed by the circuit simulation system 300.

Furthermore, in some illustrative embodiments, the interface 320, along with testing equipment interface 350, may provide a user with an interface to testing equipment 390 for applying test workloads/patterns to a hardware implementation of the integrated circuit model to thereby obtain noise measurements. For example, the testing equipment, which is generally known in the art, may apply such workloads and/or test patterns to an integrated circuit chip containing the integrated circuit corresponding to the integrated circuit model and measure the supply voltage noise generated as a result of running the integrated circuit chip using the applied workloads/test patterns. The measured supply voltage noise may be input to the simulation engine 300 for use by the guard band determination engine 360 in determining a guard band for a minimum supply voltage, as described hereafter.

The circuit model storage device 330 stores the integrated circuit model information obtained through the interface 320 for use in performing simulation. This circuit model information may include, for example, one or more netlist data structures specifying the nets of the integrated circuit model as well as other information that typically makes up an integrated circuit model as is generally known in the art. In addition, results data of actual testing of a hardware implementation of the integrated circuit model may be stored in the circuit model storage device 330 for later use by the simulation engine 300.

The circuit simulation engine 340 performs simulation of the integrated circuit model for purposes of verifying the operation of the integrated circuit model as well as predicting the minimum operational (or functional) voltage VminF at which the integrated circuit model may operate. The circuit simulation engine 340 may simulate the integrated circuit model using one or more workloads and/or test patterns that are achievable by testing equipment for verifying the operation of the integrated circuit. For example, an impulse response workload applying a logical built-in self test (LBIST) pattern to the integrated circuit model may be used to simulate the operation of the integrated circuit. The simulation results in various output results data including a noise measurement of the supply voltage.

In addition to simulating the achievable workload and/or test pattern using the integrated circuit model, results data from an actual test of a hardware implementation of the integrated circuit device may be obtained via the testing equipment interface 350. As is generally known in the art, such testing may be performed using testing equipment 390 that applies the workload and/or test pattern to the hardware comprising the integrated circuit corresponding to the integrated circuit model, e.g., an integrated circuit chip. The testing equipment 390 measures the output of the hardware as well as operational characteristics of the hardware including supply voltage noise, power dissipation, temperature, and the like. The measured operational characteristics may be provided to the simulation engine 300 from the testing equipment 390 via the testing equipment interface 350 and may be stored in the circuit model storage device 330, as mentioned above.

Moreover, the circuit simulation engine 340 may simulate the operation of the integrated circuit by applying a worst case current waveform to the integrated circuit model to thereby simulate the integrated circuit model under a worst case situation. This worst case current waveform is typically not achievable by testing equipment and thus, the worst case situation must be simulated using the simulation engine 340 and the integrated circuit model. The worst case current waveform is defined by the human designer based on, for example, the designer's understanding of the microarchitecture, instruction sets, circuit behavior, and chip-package-system interaction.

The simulations performed by the circuit simulation engine 340 with regard to the achievable workload/test pattern and the worst case current waveform may include performing power dissipation simulations, as is generally known in the art. These power dissipation simulations result in an estimate of the noise in the supply voltage for the integrated circuit device comprising the integrated circuit model. Because such simulations are generally known in the art, a detailed description is not provided herein.

The noise measurement data from the simulations and actual testing of the achievable workload/test pattern and the worst case current waveform are provided to the guard band determination engine 360. Based on measurement noise data obtained from actual testing of the hardware for an achievable workload/test pattern and simulated noise data obtained from a simulation of the integrated circuit model for the same achievable workload/test pattern, the guard band determination engine 360 determines a scaling factor for the guard band calculation. The guard band determination engine 360 further calculates the guard band based on this scaling factor and a difference between a noise of the supply voltage for the simulation of the achievable workload/test pattern and a noise of the supply voltage for a simulation of the worst case current waveform.

For example, a workload/test pattern that is achievable by the testing equipment 390 may be selected by the simulation engine 300. This workload/test pattern may be a pulse response workload of an LBIST, ABIST, or other critical test pattern. A pulse response workload is selected for the illustrative embodiments because it simplifies the correlation of measured and simulated noise data. Other workloads and/or test patterns may be used without departing from the spirit and scope of the present invention. For example, the simulation and testing of the integrated circuit device may be performed over a plurality of cycles, but would require that noise measurements and noise values obtained from simulation be correlated by a correlation mechanism.

The scaling factor k may be determined as the ratio of the measured noise value for an actual test of the integrated circuit chip using the testing equipment 390 to the noise value obtained from simulation of the same workload/test pattern using simulation of the integrated circuit model. This provides a relationship between noise values estimated by the simulation to noise values actually seen in the physical hardware. Thus, the scaling factor k is determined in accordance with the following relationship: k=Measured_noise/Simulated_noise.

The noise value obtained from the simulation of the integrated circuit model may further be used in the equation utilized by the guard band determination engine 360 to calculate the guard band. In particular, the guard band is calculated as the difference between the simulated noise obtained from the simulation of the integrated circuit model using the achievable workload and/or test pattern, and the simulated noise value obtained from a simulation of the integrated circuit model using a worst case current waveform. This difference is multiplied by the scaling factor determined in the manner described above. Thus, the guard band, or VminF voltage offset (VVO), may be calculated according to the following equation: VVO=k*(Noiseᵥₛᵢₘ_{_{—}}ₜₑₛₜₚₐₜₜₑᵣₙ−Noiseᵥₛᵢₘ_{_{—}}_{worstcase}).

The resulting guard band defined by VVO may be reported to the user of the simulation engine 300 via the report generation engine 370. It is this guard band VVO that is to be added to the minimum supply voltage VminF, determined from application of the specific workload/test pattern to the integrated circuit device, in order to obtain the real minimum supply voltage condition.

The above process for determining the guard band for VminF may be performed with regard to a plurality of different workloads and/or test patterns. Typically, such a process may be performed with regard to the most critical workloads and/or test patterns for the integrated circuit device. Each process may generate a different guard band for the different workloads and/or test patterns. Thereby, the minimum operating voltage for the integrated circuit device that achieves the least power dissipation may be determined and used with the integrated circuit device.

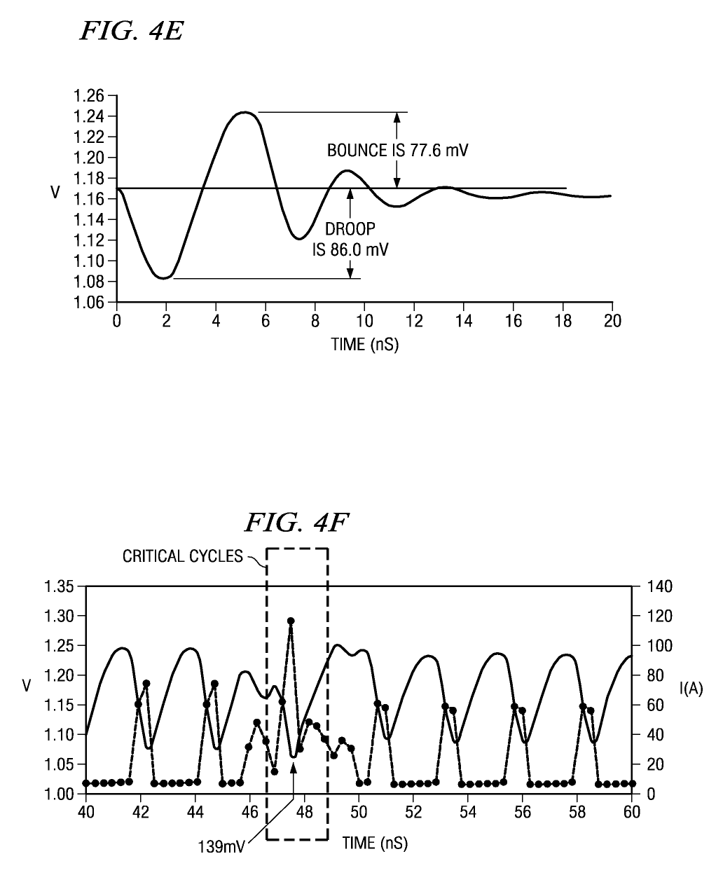

As an example implementation of the methodology utilized by the guard band determination engine 360, assume that the workload/test that is chosen to obtain simulation and test measurement results is a pseudo-impulse response (a scan shift in LBIST test). It is further assumed that the workload/test that is used to determine the minimum operational voltage VminF is an LBIST test pattern and that the worst case current waveform has been determined by a designer of the integrated circuit model to be as shown in FIG. 4A. The designer determines the worst case current waveform based on the designer's understanding of the microarchitecture, instruction sets, circuit behavior, and chip-package-system interaction, for example. As shown in FIG. 4A, this worst case current waveform has a voltage of 1.2V and frequency of 3.2 GHz. The waveform has a range of 59 amps to 130 amps, as shown.

The integrated circuit device is tested using the LBIST test pattern and an impulse current as shown in FIG. 4B. The testing is performed at an operating frequency of 3.2 GHz and over various operating voltages including 1.0 V, 1.1 V, and 1.2 V. An example of the measured impulse response waveform for an operating voltage of 1.2 V is shown in FIG. 4C. The measured noise, or droop, in the supply voltage is determined for a plurality of parts, i.e. a particular number of integrated circuit chips that are tested, and is averaged, as illustrated in Table 1 below. The number of parts used in Table 1 is only exemplary and is not intended to be limiting on the present invention. The number of parts that are used may be determined based on statistical needs and may be greater than or less than the number of parts shown in Table 1 without departing from the spirit and scope of the present invention.

TABLE 1
Average Measured Droop of Impulse Response

| Part # | Droop_1.2 V | Droop_1.1 V | Droop_1.0 V |
|---|---|---|---|
| 1 | 137.0 | 122.8 | 107.4 |
| 2 | 137.0 | 124.0 | 103.0 |
| 3 | 133.0 | 117.0 | 106.0 |
| 4 | 128.0 | 116.0 | 100.0 |
| 5 | 134.0 | 111.0 | 105.0 |
| 6 | 130.0 | 118.0 | 104.0 |
| 7 | 135.0 | 113.0 | 106.0 |
| 8 | 130.0 | 118.0 | 107.0 |
| 9 | 130.0 | 113.0 | 103.0 |
| 10 | 133.0 | 117.0 | 105.0 |
| Average | 132.7 | 117.0 | 104.6 |

The average droop over the 10 parts in Table 1 is used to calculate the scaling factor along with the droop in the simulated impulse response for the same workload/test pattern. For example, assume that, through simulation of the integrated circuit device, using the same impulse response LBIST test pattern used to measure the droop in FIG. 4C, the simulated impulse response obtained is as shown in FIG. 4D. As shown in FIG. 4D, the droop, or noise, for the simulated impulse response is approximately 116.2 mV. Thus, the worst droop in the simulation is 116.2 mV and the average worst droop measured is 132.7 mV for an operating voltage of 1.2V. As a result, the scaling factor k is 132.7/116.2 or 1.142. Thus, if a test pattern has a simulated droop of Vnoise, its expected measured result of the actual hardware implementation should be k*Vnoise or 1.142*Vnoise.

Now assume that through application of the worst case current waveform of FIG. 4A to the integrated circuit model, an impulse response is obtained from the simulation as shown in FIG. 4E. As shown in FIG. 4E, the worst droop is approximately 86.0 mV.

FIG. 4F illustrates a voltage waveform obtained from simulation of a LBIST pattern to the integrated circuit model in order to obtain a VminF value. As shown in FIG. 4F, the waveform has a worst droop of approximately 139 mV, measured from the nominal voltage of 1.2V.

From these various waveforms, the equation for the guard band, VVO, may be evaluated. For the example shown in FIGS. 4A-4F, the value for VVO may be obtained as follows:

VVO=k*((Noise_{Vsim}_{_{—}}ₜₑₛₜₚₐₜₜₑᵣₙ−Noise_{Vsim}_{_{—}}_{worstcase})

VVO=1.142*(139.0 mV−86.0 mV)=60.5 mV

Thus, a guard band of 60.5 mV should be subtracted from the VminF value obtained from the simulation of the LBIST pattern to the integrated circuit model. If the VVO value were to be negative, i.e. the simulation of the worst case current waveform results in greater noise than the simulation of the test pattern, then the guard band value is added to the VminF value. Therefore, through the mechanisms of the illustrative embodiments, a new VminF value may be calculated based on a calculated guard band for a workload/test pattern applied to the integrated circuit model/device.

It should be appreciated that the exemplary operation described above with regard to FIGS. 4A-4F is only exemplary. Modifications to the above operation may be performed without departing from the spirit and scope of the illustrative embodiments. Such modifications may take many different forms and thus, all of these modifications cannot be described herein. So long as the guard band is determined based on a relationship between simulated noise for a workload/test pattern and simulated noise for a worst case current waveform, any other modifications to the above operation are intended to be within the spirit and scope of the illustrative embodiments. For example, in some illustrative embodiments, a different relationship may be utilized for determining the scaling factor for the guard band calculation. Moreover, a different relationship between the simulated noise for a workload/test pattern and simulated noise for a worst case current waveform than that illustrated above may be utilized in other illustrative embodiments.

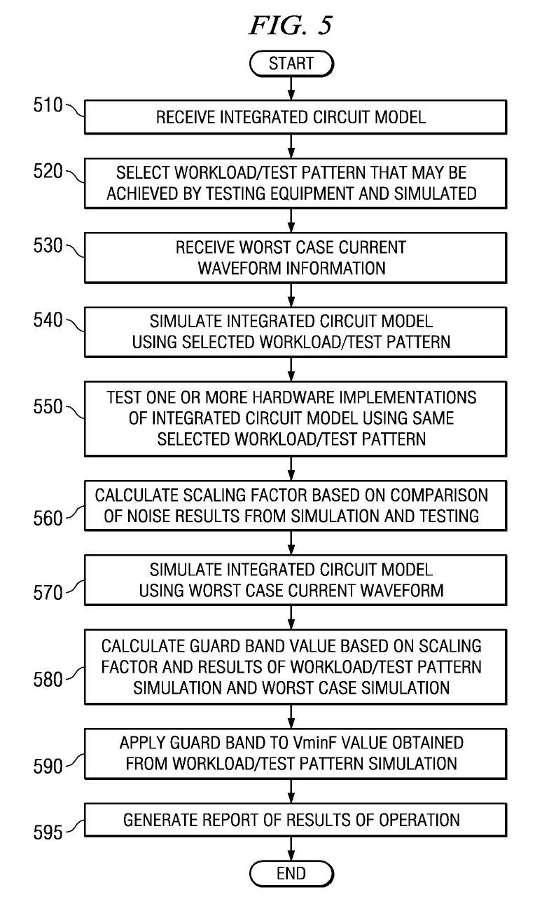

FIG. 5 is a flowchart outlining an exemplary operation of an illustrative embodiment for calculating and applying a guard band to a minimum operational voltage determined through simulation of an integrated circuit device. It will be understood that each block of the flowchart illustration, and combinations of blocks in the flowchart illustration, can be implemented by computer program instructions. These computer program instructions may be provided to a processor or other programmable data processing apparatus to produce a machine, such that the instructions which execute on the processor or other programmable data processing apparatus create means for implementing the functions specified in the flowchart block or blocks. These computer program instructions may also be stored in a computer-readable memory or storage medium that can direct a processor or other programmable data processing apparatus to function in a particular manner, such that the instructions stored in the computer-readable memory or storage medium produce an article of manufacture including instruction means which implement the functions specified in the flowchart block or blocks.

Accordingly, blocks of the flowchart illustration support combinations of means for performing the specified functions, combinations of steps for performing the specified functions and program instruction means for performing the specified functions. It will also be understood that each block of the flowchart illustration, and combinations of blocks in the flowchart illustration, can be implemented by special purpose hardware-based computer systems which perform the specified functions or steps, or by combinations of special purpose hardware and computer instructions.

As shown in FIG. 5, the operation starts with the simulation engine receiving an integrated circuit model to be simulated (step 510). The simulation engine selects a workload/test pattern that may be achieved by the testing equipment and simulated by the simulation engine (step 520). The simulation engine further receives a worst case current waveform (step 530). The simulation engine simulates the integrated circuit model using the selected workload/test pattern (step 540) and tests one or more hardware implementations of the integrated circuit model using the same selected workload/test pattern (step 550). The simulation engine calculates a scaling factor based on a comparison of the noise results of the simulation with the noise results of the hardware testing (step 560).

The simulation engine simulates the integrated circuit model using the worst case current waveform (step 570). The simulation engine uses the noise result of the worst case current waveform simulation along with the noise result of the workload/test pattern simulation and the scaling factor to generate a guard band value or VminF voltage offset (step 580). The guard band or VminF voltage offset may then be applied to a VminF value obtained from the simulation of the workload/test pattern to obtain a smallest operating voltage that generates a least amount of power dissipation (step 590). The results of the above analysis and calculations may be reported to a user (step 595) and the operation terminates.

Thus, the illustrative embodiments provide a mechanism for determining a guard band for an operational voltage of an integrated circuit device. The mechanisms of the illustrative embodiment determine the guard band based on a relationship of noise values obtained a simulation of the integrated circuit device to actually measured noise values of hardware implementations of the integrated circuit device. These guard band is further determined based on noise results of a simulation of the integrated circuit device under an achievable workload/test pattern and under a worst case current waveform. As a result, a more accurate determination of a guard band for the minimum operating voltage of the integrated circuit device is obtained when compared to traditional methods for determining the guard band.

It should be appreciated that the illustrative embodiments may take the form of an entirely hardware embodiment, an entirely software embodiment or an embodiment containing both hardware and software elements. In one exemplary embodiment, the mechanisms of the illustrative embodiments are implemented in software, which includes but is not limited to firmware, resident software, microcode, etc.

Furthermore, the illustrative embodiments may take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium may be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a data processing system, for determining a guard band for an operating voltage of an integrated circuit device, comprising:
simulating the integrated circuit device under a selected workload to thereby generate first simulated results;
simulating the integrated circuit device using a worst case current waveform to thereby generate second simulated results;
calculating a guard band based on the first simulated results and second simulated results; and
applying the guard band to an operating voltage of the integrated circuit device to obtain a minimum operating voltage for the integrated circuit device.

2. The method of claim 1, further comprising:
measuring a hardware implementation of the integrated circuit device under the selected workload to thereby generate measured results, wherein calculating the guard band is further based on the measured results.

3. The method of claim 2, wherein calculating the guard band comprises:
calculating a scaling factor based on a relationship between the measured results and the first simulated results.

4. The method of claim 3, wherein calculating the guard band further comprises:
calculating a difference between the first simulated results and the second simulated results; and
multiplying the difference by the scaling factor to obtain the guard band.

5. The method of claim 3, wherein the relationship is a ratio of the measured results to the first simulated results.

6. The method of claim 1, wherein the first simulated results are an estimate of noise of a supply voltage applied to the integrated circuit device based on the selected workload, and wherein the second simulated results are an estimate of noise of the supply voltage applied to the integrated circuit device based on the worst case current waveform.

7. The method of claim 1, wherein the selected workload is a workload that may be generated by testing equipment to verify an operation of a hardware implementation of the integrated circuit device.

8. The method of claim 7, wherein the selected workload is one of a logical built-in self test (LBIST) test pattern or an array built-in self test (ABIST) test pattern.

9. The method of claim 1, wherein simulating the integrated circuit device comprises performing power dissipation simulations.

10. The method of claim 1, wherein the selected workload is an impulse response workload of a logical built-in self test.

11. A computer program product comprising a computer useable medium having a computer readable program, wherein the computer readable program, when executed on a computing device, causes the computing device to:
simulate the integrated circuit device under a selected workload to thereby generate first simulated results;
simulate the integrated circuit device using a worst case current waveform to thereby generate second simulated results;
calculate a guard band based on the first simulated results and second simulated results; and
apply the guard band to an operating voltage of the integrated circuit device to obtain a minimum operating voltage for the integrated circuit device.

12. The computer program product of claim 11, wherein the computer readable program further causes the computing device to:
measure a hardware implementation of the integrated circuit device under the selected workload to thereby generate measured results, wherein calculating the guard band is further based on the measured results.

13. The computer program product of claim 12, wherein the computer readable program causes the computing device to calculate the guard band by:
calculating a scaling factor based on a relationship between the measured results and the first simulated results.

14. The computer program product of claim 13, wherein the computer readable program causes the computing device to calculate the guard band by:
calculating a difference between the first simulated results and the second simulated results; and
multiplying the difference by the scaling factor to obtain the guard band.

15. The computer program product of claim 13, wherein the relationship is a ratio of the measured results to the first simulated results.

16. The computer program product of claim 11, wherein the first simulated results are an estimate of noise of a supply voltage applied to the integrated circuit device based on the selected workload, and wherein the second simulated results are an estimate of noise of the supply voltage applied to the integrated circuit device based on the worst case current waveform.

17. The computer program product of claim 11, wherein the selected workload is a workload that may be generated by testing equipment to verify an operation of a hardware implementation of the integrated circuit device.

18. The computer program product of claim 17, wherein the selected workload is one of a logical built-in self test (LBIST) test pattern or an array built-in self test (ABIST) test pattern.

19. The computer program product of claim 11, wherein the computer readable program causes the computing device to simulate the integrated circuit device by performing power dissipation simulations.

20. An apparatus, comprising:
a processor; and
a memory coupled to the processor, wherein the memory comprises instructions which, when executed by the processor, cause the processor to:
simulate the integrated circuit device under a selected workload to thereby generate first simulated results;
simulate the integrated circuit device using a worst case current waveform to thereby generate second simulated results;
calculate a guard band based on the first simulated results and second simulated results; and
apply the guard band to an operating voltage of the integrated circuit device to obtain a minimum operating voltage for the integrated circuit device.
